(19) United States
(12) Patent Application Publication
(10) Pub. No.: US 2026/0358190 A1
(43) Pub. Date: Nov. 12, 2026

(54) ALIGNMENT DEVICE FOR MULTICORE OPTICAL FIBER, MANUFACTURING DEVICE FOR MULTICORE OPTICAL FIBER RIBBON, MANUFACTURING DEVICE FOR MULTICORE OPTICAL FIBER UNIT, ALIGNMENT METHOD FOR MULTICORE OPTICAL FIBER, MANUFACTURING METHOD FOR MULTICORE OPTICAL FIBER RIBBON, MANUFACTURING METHOD FOR MULTICORE OPTICAL FIBER UNIT, INSPECTION DEVICE FOR MULTICORE OPTICAL FIBER RIBBON, AND INSPECTION METHOD FOR MULTICORE OPTICAL FIBER RIBBON

(71) Applicant: Fujikura Ltd., Tokyo (JP)

(72) Inventor: Itaru Ishida, Sakura-shi (JP)

(73) Assignee: Fujikura Ltd., Tokyo (JP)

(21) Appl. No.: 19/125,135

(22) PCT Filed: Jun. 29, 2023
(86) PCT No.: PCT/JP2023/024179

§ 371 Date: Apr. 28, 2025

(30) Foreign Application Priority Data
Oct. 31, 2022 (JP) 2022-174787

(51) Int. Cl. G01M 11/00; G02B 6/36

(52) U.S. Cl. CPC G01M 11/30; G02B 6/3604

(57) ABSTRACT

An alignment device for a multicore optical fiber includes: a fiber rotator that changes a rotation angle of the multicore optical fiber around an axis; a fiber bender that bends the multicore optical fiber whose rotation angle has been changed in a predetermined direction; a skew measurer that causes light to enter a pair of cores and of the multicore optical fiber and receives light emitted from the pair of cores and to measure a skew value of each light; and a controller that controls the fiber rotation unit to adjust the rotation angle of the multicore optical fiber such that the skew value has a predetermined value.

### TECHNICAL FIELD

The present invention relates to an alignment device for a multicore optical fiber, a manufacturing device for a multicore optical fiber ribbon, a manufacturing device for a multicore optical fiber unit, an alignment method for a multicore optical fiber, a manufacturing method for a multicore optical fiber ribbon, a manufacturing method for a multicore optical fiber unit, an inspection device for a multicore optical fiber ribbon, and an inspection method for a multicore optical fiber ribbon.

### BACKGROUND

It has been known to transmit a plurality of signals by light propagating through each of a plurality of cores using a multicore optical fiber in which outer circumferences of the cores are surrounded by one cladding. In a case of connecting the multicore optical fibers to each other, it is necessary to perform alignment of the multicore optical fibers to be connected in a rotation direction around an axis and to cause the cores of the multicore optical fibers to face each other.

In Patent Literature 1, a quantity of light leaking from the core is detected by bending the multicore optical fiber and propagating light through a predetermined core, and the multicore optical fiber is rotated around the axis such that the quantity of light becomes substantially constant, thereby aligning the multicore optical fiber in the rotation direction.
[Patent Literature 1] JP 6046311 B2
[Patent Literature 2] JP 6226905 B2

However, in the alignment method described in Patent Literature 1, even when the multicore optical fiber is rotated around the axis, a change in the quantity of leaking light is small. Therefore, it is difficult to detect misalignment of the multicore optical fiber in the rotation direction around the axis, and it is difficult to perform alignment with high accuracy.

### SUMMARY

Embodiments of the present disclosure provide an alignment device for a multicore optical fiber capable of achieving alignment of the multicore optical fiber in a rotation direction with high accuracy, a manufacturing device for a multicore optical fiber ribbon, a manufacturing device for a multicore optical fiber unit, an alignment method for a multicore optical fiber, a manufacturing method for a multicore optical fiber ribbon, a manufacturing method for a multicore optical fiber unit, an inspection device for a multicore optical fiber ribbon capable of detecting misalignment of the multicore optical fiber in the rotation direction with high accuracy, and an inspection method for a multicore optical fiber ribbon.

A first aspect of the present invention is an alignment device for a multicore optical fiber, the alignment device including: a fiber rotation unit (fiber rotator) that changes a rotation angle of the multicore optical fiber around an axis; a fiber bending unit (fiber bender) that bends the multicore optical fiber whose rotation angle has been changed in a predetermined direction; a skew measurement unit (skew measurer) that measures a skew value of light propagating through a pair of cores of the multicore optical fiber; and a control unit (controller) that controls the fiber rotation unit to adjust the rotation angle of the multicore optical fiber such that the skew value has a predetermined value.

In a case where the multicore optical fiber is rotated around the axis in a state in which the multicore optical fiber is bent in the predetermined direction, an arrangement direction of the pair of cores with respect to a bending direction is changed, and the skew value of the light propagating through the pair of cores is changed. Therefore, the arrangement direction of the pair of cores can be set to a predetermined direction with respect to the bending direction by adjusting the rotation angle such that the skew value has the predetermined value. Since the change in the skew value with respect to the rotation angle can be measured more precisely than a change in leaked light, the alignment in the rotation direction can be performed with higher accuracy than the alignment of the multicore optical fiber described in Patent Literature 1.

A second aspect of the present invention is the multicore optical fiber alignment device according to the first aspect, in which the control unit adjusts the rotation angle such that the skew value has a maximum value or a minimum value.

In this case, since an absolute value of the skew value is large, a resolution can be made higher than in a case of adjusting the skew value to a skew value that is not the maximum value or the minimum value, and the alignment can be performed with higher accuracy. In a case where the arrangement direction of the pair of cores coincides with the bending direction, the skew value is maximized or minimized.

In the first or second aspect, the pair of cores may be a core pair farthest from each other among a plurality of cores in the multicore optical fiber.

A third aspect of the present invention is a manufacturing device for a multicore optical fiber ribbon, the manufacturing device including: a feeding unit (feeder) that feeds one or more multicore optical fibers; the alignment device according to the first or second aspect that performs alignment of an orientation of at least one multicore optical fiber fed from the feeding unit in a rotation direction; and a ribbonization unit (ribbonizer) that ribbonizes a plurality of optical fibers including the multicore optical fiber aligned by the alignment device.

With the manufacturing device for a multicore optical fiber ribbon, it is possible to manufacture the multicore optical fiber ribbon in which the rotation directions of the multicore optical fibers are aligned with high accuracy.

A fourth aspect of the present invention is a manufacturing device for a multicore optical fiber unit, the manufacturing device including: the alignment device according to the first or second aspect; and a connection unit (fiber connector) that connects the multicore optical fiber aligned by the alignment device to another optical component.

With the manufacturing device for a multicore optical fiber unit, since the rotation direction of the multicore optical fiber is aligned with high accuracy, the multicore optical fiber can be connected to another optical component in a state in which the rotation direction is appropriately aligned. Therefore, it is possible to manufacture the multicore optical fiber unit in which the multicore optical fiber whose rotation direction has been appropriately aligned is connected to another optical component.

A fifth aspect of the present invention is an alignment method for a multicore optical fiber, the alignment method including: a fiber rotation step of changing a rotation angle of the multicore optical fiber around an axis; a fiber bending step of bending the multicore optical fiber whose rotation angle has been changed in a predetermined direction; and a skew measurement step of measuring a skew value of light propagating through a pair of cores of the multicore optical fiber, in which in the fiber rotation step, the rotation angle of the multicore optical fiber is adjusted such that the skew value has a predetermined value.

According to this aspect, similarly to the first aspect, it is possible to perform alignment of the multicore optical fiber in the rotation direction with high accuracy.

A sixth aspect of the present invention is the alignment method according to the fifth aspect, in which in the fiber rotation step, the rotation angle is adjusted such that the skew value has a maximum value or a minimum value.

According to this aspect, the alignment can be performed with higher accuracy similarly to the second aspect.

A seventh aspect of the present invention is the multicore optical fiber alignment method according to the fifth or sixth aspect, in which the pair of cores is a core pair farthest from each other among a plurality of cores in the multicore optical fiber.

If the arrangement direction of the pair of cores with respect to the bending direction of the multicore optical fiber is constant, the skew value of the light propagating through the core pair farthest from each other becomes the largest, and when the rotation angle of the multicore optical fiber deviates, the change in the skew value becomes large. Therefore, according to this aspect, the skew value can be measured with higher accuracy, and the alignment of the multicore optical fiber in the rotation direction can be performed with higher accuracy.

An eighth aspect of the present invention is a manufacturing method for a multicore optical fiber ribbon, the manufacturing method including: a feeding step of feeding one or more multicore optical fibers; an alignment step of performing alignment of an orientation of at least one of the multicore optical fibers fed in the feeding step in a rotation direction by the alignment method according to any one of the fifth to seventh aspects; and a ribbonization step of ribbonizing a plurality of the multicore optical fibers aligned in the alignment step.

According to this aspect, similarly to the third aspect, it is possible to manufacture the multicore optical fiber ribbon in which the rotation directions of the multicore optical fibers are aligned with high accuracy.

A ninth aspect of the present invention is a manufacturing method for a multicore optical fiber unit, the manufacturing method including: an alignment step of performing alignment of an orientation of the multicore optical fiber in a rotation direction by the alignment method according to any one of the fifth to seventh aspects; and a connection step of connecting the multicore optical fiber aligned in the alignment step to another optical component.

According to this aspect, similarly to the fourth aspect, it is possible to manufacture the multicore optical fiber unit in which the multicore optical fiber whose rotation direction has been appropriately aligned is connected to another optical component.

A tenth aspect of the present invention is an inspection device for a multicore optical fiber ribbon, the inspection device including: a fiber bending unit that bends a multicore optical fiber by bending the multicore optical fiber ribbon including one or more multicore optical fibers; a skew measurement unit that measures a skew value of light propagating through a pair of cores in at least one multicore optical fiber; and a determination unit that determines that the skew value in at least one multicore optical fiber is outside a predetermined range.

According to this aspect, misalignment of the multicore optical fiber can be detected with high accuracy by detecting that the skew value is outside the predetermined range at a portion bent in the fiber bending unit. In addition, in a case of detecting a section in which misalignment of the multicore optical fiber in the rotation direction has occurred, the section can be detected with high accuracy by sequentially feeding the multicore optical fiber ribbon to the fiber bending unit.

In the tenth aspect, the pair of cores may be arranged in a direction perpendicular to an arrangement direction of a plurality of the multicore optical fibers.

An eleventh aspect of the present invention is an inspection method for a multicore optical fiber ribbon, the inspection method including: a fiber bending step of bending a multicore optical fiber by bending the multicore optical fiber ribbon including one or more multicore optical fibers; a skew measurement step of measuring a skew value of light propagating through a pair of cores in at least one multicore optical fiber; and a determination step of determining that the skew value in at least one multicore optical fiber is outside a predetermined range.

According to this aspect, similarly to the tenth aspect, the misalignment of the multicore optical fiber can be detected with high accuracy.

A twelfth aspect of the present invention is the inspection method according to the eleventh aspect, in which the multicore optical fiber ribbon includes a plurality of optical fibers arranged in parallel, the plurality of optical fibers including the multicore optical fiber, and the pair of cores is arranged in a direction perpendicular to an arrangement direction of the optical fibers.

The multicore optical fiber ribbon is usually bent in a direction perpendicular to the arrangement direction of the optical fibers. Further, in a case where the arrangement direction of the pair of cores coincides with the bending direction, the skew value is maximized or minimized. Therefore, according to this aspect, since the absolute value of the skew value is large, the resolution of the skew value can be increased, and the misalignment can be detected with higher accuracy.

As described above, one or more embodiments of the present invention provide the alignment device for a multicore optical fiber capable of achieving alignment of the multicore optical fiber in the rotation direction with high accuracy, the manufacturing device for a multicore optical fiber ribbon, the manufacturing device for a multicore optical fiber unit, the alignment method for a multicore optical fiber, the manufacturing method for a multicore optical fiber ribbon, the manufacturing method for a multicore optical fiber unit, the inspection device for a multicore optical fiber ribbon capable of detecting misalignment of the multicore optical fiber in the rotation direction with high accuracy, and the inspection method for a multicore optical fiber ribbon.

### BRIEF DESCRIPTION OF DRAWINGS

FIG. 1 is a view illustrating an example of a cross-sectional view of a multicore optical fiber.

FIG. 2 is a view illustrating a state in which the multicore optical fiber of FIG. 1 is bent.

FIG. 3 is a diagram illustrating a relationship between a bending radius and a skew value per unit length of light propagating through a pair of cores in the multicore optical fiber of FIGS. 1 and 2.

FIG. 4 is a diagram illustrating a relationship between an angle between an arrangement direction of the pair of cores and a bending direction of the multicore optical fiber and the skew value per unit length.

FIG. 5 is a view illustrating a state in an example of a multicore optical fiber ribbon according to a first embodiment of the present invention.

FIG. 6 is a view illustrating a manufacturing device for the multicore optical fiber ribbon.

FIG. 7 is a view illustrating a state of a fiber rotation unit.

FIG. 8 is a flowchart illustrating a manufacturing method for the multicore optical fiber ribbon.

FIG. 9 is a view illustrating an example of a multicore optical fiber unit according to a second embodiment of the present invention.

FIG. 10 is a view illustrating a manufacturing device for the multicore optical fiber unit of FIG. 9.

FIG. 11 is a flowchart illustrating a manufacturing method for the multicore optical fiber unit.

FIG. 12 is a view illustrating an inspection device for a multicore optical fiber ribbon according to a third embodiment of the present invention.

FIG. 13 is a flowchart illustrating an inspection method for the multicore optical fiber ribbon.

FIG. 14 is a view illustrating a modified example of the multicore optical fiber ribbon.

### DETAILED DESCRIPTION

Hereinafter, embodiments of an alignment device for a multicore optical fiber, a manufacturing device for a multicore optical fiber ribbon, a manufacturing device for a multicore optical fiber unit, an alignment method for a multicore optical fiber, a manufacturing method for a multicore optical fiber ribbon, a manufacturing method for a multicore optical fiber unit, an inspection device for a multicore optical fiber ribbon, and an inspection method for a multicore optical fiber ribbon according to the present invention will be described in detail with reference the drawings. The embodiments exemplified below are intended to facilitate understanding of the present invention and are not intended to limit the present invention. The present invention can be changed and modified from the embodiments without departing from the gist of the present invention. For easy understanding, scales illustrated in the respective drawings may be different from scales described in the following description.

### First Embodiment

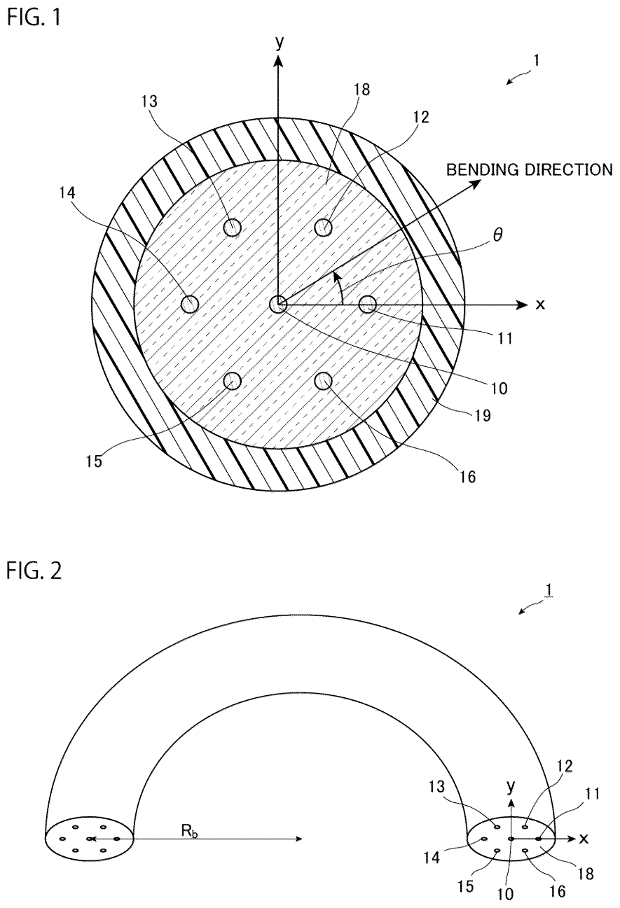

First, a skew of a multicore optical fiber will be described. FIG. 1 is a view illustrating an example of a cross-sectional view of a multicore optical fiber. As illustrated in FIG. 1, a multicore optical fiber 1 in the present description includes a plurality of cores 10 to 16, a cladding 18 that surrounds an outer circumferential surface of each of the cores 10 to 16 without a gap, and a protective layer 19 that covers an outer circumferential surface of the cladding 18. A refractive index of each of the cores 10 to 16 is higher than a refractive index of the cladding 18. Each of the cores 10 to 16 and the cladding 18 are made of glass doped with a dopant as necessary. The protective layer 19 may be made of a resin and may include a plurality of layers having different hardnesses from each other.

In the present description, the total number of cores is seven, one core 10 is arranged along a central axis of the cladding 18, and the plurality of cores 11 to 16 are arranged at equal intervals around the one core 10. In addition, the multicore optical fiber 1 is not twisted, and the plurality of cores 10 to 16 are linear when the cladding 18 is linear.

FIG. 2 is a view illustrating a state in which the multicore optical fiber 1 of FIG. 1 is bent. In FIG. 2, the protective layer 19 is omitted. Here, a predetermined radial direction from the center of the cladding 18 is defined as an x axis, a radial direction orthogonal to the x axis is defined as a y axis, and an angle formed between a direction in which the multicore optical fiber 1 is bent and the x axis is defined as 0. In the examples of FIGS. 1 and 2, a straight line passing through the core 10, the core 11, and the core 14 is the x axis, the core 11 is positioned on an outer side of the bend, and the core 14 is positioned on an inner side of the bend. When the x axis, the y axis, and the angle θ are defined as described above, the angle θ is 180° in a case where the multicore optical fiber 1 is bent as illustrated in FIG. 2.

In a case where a core m and a core n form a pair of cores among the core 10 to 16 of the multicore optical fiber 1, a skew value S, which is a group delay difference between light propagating through the core m and light propagating through the core n, is expressed by the following formula with i as m or n as described in detail in Patent Literature 2.

$$S = \frac{L}{c} [ ( {N}_{1 m} - {N}_{1 n} ) + \frac{F}{{R}_{b}} ( {G}_{m} - {G}_{n} ) + \frac{1}{{R}_{b}} ( {G}_{m} {N}_{1 m} - {G}_{n} {N}_{1 n} ) + \frac{F}{{R}_{b}^{2}} ( {G}_{m}^{2} - {G}_{n}^{2} ) ]$$

$$F = - {B}_{2} {C}_{12} - {B}_{1} ( {C}_{12} + {C}_{11} )$$

$${G}_{i} = {x}_{i} cos θ - {y}_{i} sin θ$$

$${C}_{11} = E ( 1 - ν ) / [ ( 1 + ν ) ( 1 - 2 ν ) ]$$

$${C}_{12} = E ν / [ ( 1 + ν ) ( 1 - 2 ν ) ]$$

Here, L represents a length of an optical fiber, c represents a speed of the light in vacuum, N₁ₘ represents a group refractive index of the core m, N₁ₙ represents a group refractive index of the core n, R_{b} represents a bending radius of the multicore optical fiber, B₁ represents a photoelastic coefficient for a normal light ray in each core, B₂ represents a photoelastic coefficient for an abnormal light ray in each core, xₘ and yₘ represent coordinate positions of the core m based on the center of the cladding 18, xₙ and yₙ represent coordinate positions of the core n based on the center of the cladding 18, E represents a Young's modulus of the core, and ν represents a Poisson's ratio of the core.

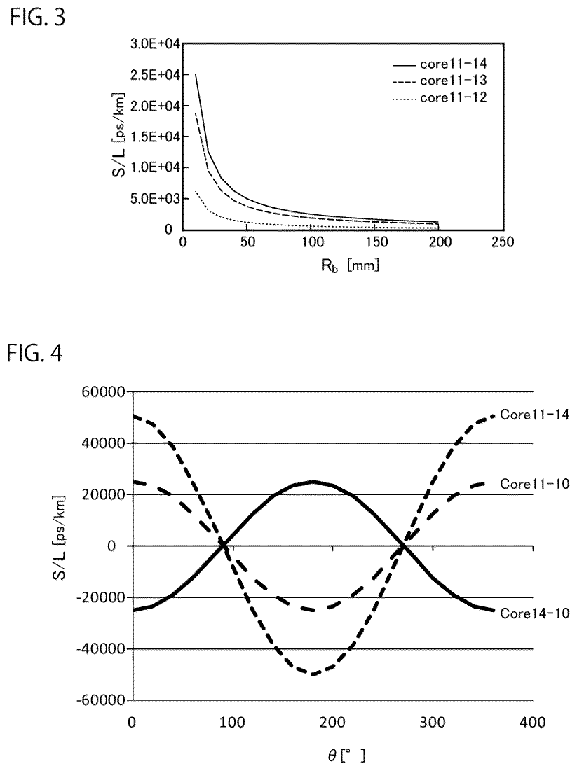

The skew value S can be obtained for all combinations of the pair of cores in the core 10 to 16 of the multicore optical fiber 1. FIG. 3 is a diagram illustrating a relationship between the bending radius and the skew value S per unit length of the light propagating through the pair of cores in the multicore optical fiber 1 of FIGS. 1 and 2. FIG. 3 illustrates the skew value S between the core 11 and the core 14, the skew value S between the core 11 and the core 13, and the skew value S between the core 11 and the core 12 of the multicore optical fiber 1. In FIG. 3, a bending direction is an x-axis direction, that is, 0=180°. In addition, the group refractive indexes N₁ₘ and N₁ₙ of the pair of cores have the same value. That is, the skew value S is zero in a case where the multicore optical fiber 1 is in a linear state. As can be seen from FIG. 3, the skew value S increases as the bending radius decreases, and the skew value S rapidly increases in a region where the bending radius is small.

FIG. 4 is a diagram illustrating a relationship between the angle θ between an arrangement direction of the pair of cores and the bending direction of the multicore optical fiber 1, and the skew value S per unit length.

FIG. 4 illustrates the skew value S of the light propagating through two of the cores 10, 11, and 14 when the multicore optical fiber 1 is bent at the predetermined bending radius R_{b}. In FIG. 4, the group refractive indexes of the cores have the same value. In FIG. 4, the skew value S becomes 0 in a case where θ=90° and 270°, that is, in a case of bending in a direction of the y axis, and the skew value S becomes maximum or minimum in a case where θ=0° and 180°, that is, in a case of bending in the direction of the x axis. That is, an absolute value of the skew value S in a case where the pair of cores is arranged in the bending direction is larger than that of the skew value S in a case where the pair of cores is arranged not in the bending direction. An absolute value of the skew value S between the core 11 and the core 14 is larger than an absolute value of the skew value S between the core 11 and the core 10 and an absolute value of the skew value S between the core 14 and the core 10. That is, in a case where the arrangement direction of the pair of cores with respect to the bending direction is constant, the larger the core pitch between the pair of cores, the larger the absolute value of the skew value S. This is because, in a case where the multicore optical fiber is bent, a difference in curvature radius between the core positioned on an inner circumferential side of the bend and the core positioned on an outer circumferential side of the bend is larger, and a transmission path length difference and an effective group refractive index difference between the pair of cores due to the bend are larger in a case where the pair of cores is arranged in the bending direction or a case where the core pitch between the pair of cores is large, as compared to a case where the pair of cores is not arranged in the bending direction or a case where the core pitch between the pair of cores is not large. For example, in a case where the multicore optical fiber 1 is bent as illustrated in FIG. 2, the skew value S between the core 12 and the core 15 is the skew value S between the core 11 and the core 14 at θ=−60° (θ=300°).

Next, the multicore optical fiber ribbon will be described.

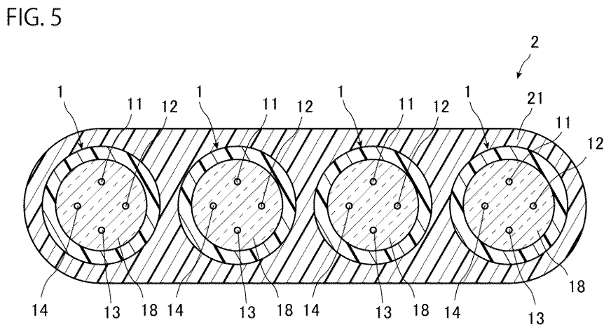

FIG. 5 is a view illustrating a state in an example of the multicore optical fiber ribbon. In the example of FIG. 5, a multicore optical fiber ribbon 2 includes a plurality of multicore optical fibers 1 and a ribbon coating 21. In this example, the multicore optical fiber ribbon 2 includes four multicore optical fibers 1.

The multicore optical fibers 1 are arranged in parallel to each other. In addition, in the example of FIG. 5, the multicore optical fiber 1 includes four cores 11 to 14 unlike the multicore optical fiber 1 of FIG. 1, and the cores 11 to 14 are arranged at positions of apexes of a square centered on the center of the cladding 18. In this example, a pair of cores 11 and 13 is arranged in a direction perpendicular to an arrangement direction of the plurality of multicore optical fibers 1. The pair of cores 11 and 13 is a core pair farthest from each other like a pair of cores 12 and 14 among core pairs of the cores in the multicore optical fiber 1. The pair of cores 12 and 14 is arranged in the arrangement direction of the plurality of multicore optical fibers 1.

The ribbon coating 21 covers outer circumferential surfaces of the multicore optical fibers 1 to integrate the respective multicore optical fibers 1. A main surface of the ribbon coating 21 has a flat shape in the arrangement direction of the plurality of multicore optical fibers 1. Therefore, the multicore optical fiber ribbon 2 has a flat string shape. In this example, a shape of a cross section perpendicular to a longitudinal direction is a substantially oval track shape. The ribbon coating 21 is made of a resin. The resin of the ribbon coating 21 may be the same type of resin as the protective layer 19, or may be a different type of resin.

Next, manufacturing of the multicore optical fiber ribbon 2 will be described.

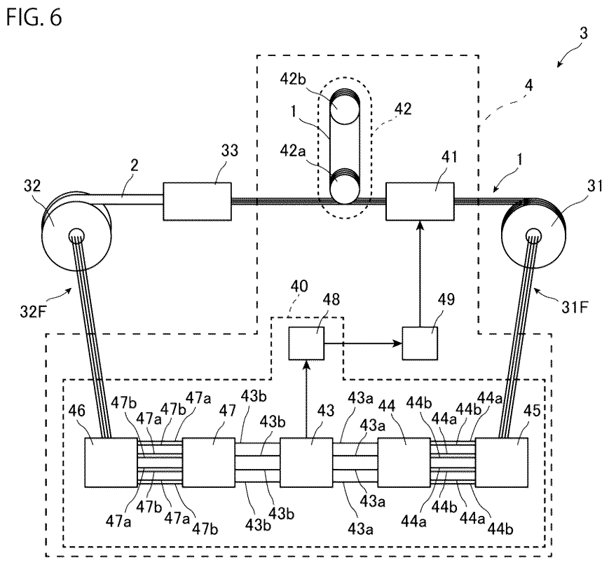

FIG. 6 is a view illustrating a manufacturing device for the multicore optical fiber ribbon 2. As illustrated in FIG. 6, a manufacturing device 3 for the multicore optical fiber ribbon 2 according mainly includes a feeding unit 31, a winding unit 32, an alignment device 4, and a ribbonization unit 33.

The feeding unit 31 includes, for example, a reel, and one end sides of the plurality of multicore optical fibers 1 are wound around the feeding unit 31 in parallel. The feeding unit 31 can rotate to feed the plurality of multicore optical fibers 1. The feeding unit 31 has, for example, a configuration in which a plurality of reels are arranged in parallel. One ends of the respective multicore optical fibers 1 are optically and individually connected to the same number of multicore optical fibers 31F as the number of multicore optical fibers 1 by an optical rotary joint incorporated in the feeding unit 31. The optical rotary joint is a joint component between optical fibers capable of maintaining optical connection between the multicore optical fiber 1 and the multicore optical fiber 31F even when the feeding unit 31 rotates. The feeding unit 31 may include a plurality of reels arranged in parallel with each other.

The alignment device 4 is a device that aligns an orientation of the multicore optical fiber 1 fed from the feeding unit 31 in a rotation direction around an axis. Details of the alignment device 4 are described below

The ribbonization unit 33 ribbonizes the plurality of multicore optical fibers 1 aligned by the alignment device 4. The ribbonization unit 33 includes, for example, a die for applying an uncured resin to be the ribbon coating 21 onto the outer circumferential surface of each multicore optical fiber 1, and a curing portion for curing the resin applied to the multicore optical fiber 1 having passed through the die. When the resin applied to each multicore optical fiber 1 is integrated when the multicore optical fiber 1 is fed from the die, the plurality of multicore optical fibers 1 are ribbonized to form the multicore optical fiber ribbon 2 illustrated in FIG. 5. Examples of the resin that forms the ribbon coating 21 include an ultraviolet curable resin, a thermosetting resin, and a thermoplastic resin.

The winding unit 32 includes, for example, a reel, and can rotate to wind the multicore optical fiber ribbon 2. The other ends of the respective multicore optical fibers 1 in the multicore optical fiber ribbon 2 are optically and individually connected to the same number of multicore optical fibers 32F as the number of multicore optical fibers 1 by an optical rotary joint incorporated in the winding unit 32. Therefore, it is possible to maintain optical connection between the multicore optical fiber 1 and the multicore optical fiber 32F even when the winding unit 32 rotates.

The alignment device 4 mainly includes a fiber rotation unit 41, a fiber bending unit 42, a skew measurement unit 40, and a control unit 49. The skew measurement unit 40 of this example mainly includes a network analyzer 43, channel selectors 44 and 47, a fan-in device 45, a fan-out device 46, and an arithmetic operation unit 48.

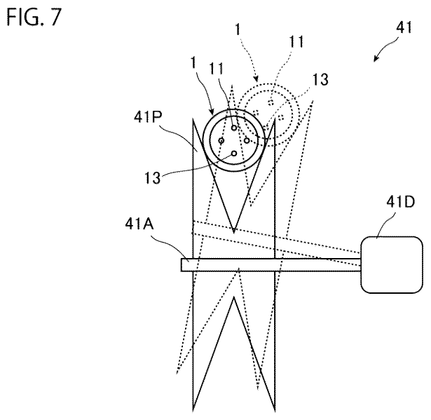

The fiber rotation unit 41 changes a rotation angle of the multicore optical fiber 1 around the axis. FIG. 7 is a view illustrating an example of the fiber rotation unit 41. As illustrated in FIG. 7, the fiber rotation unit 41 mainly includes a pulley 41P, a pulley shaft 41A, and a drive unit 41D. The pulley 41P is a disc-shaped member having a side surface on which a V-shaped groove is provided. The multicore optical fiber 1 fed from the feeding unit 31 is pinched in the V-shaped groove. A through-hole is formed in a thickness direction at the center of the pulley 41P, and the pulley shaft 41A is inserted into the through-hole. Therefore, the pulley 41P can rotate around the pulley shaft 41A. One end of the pulley shaft 41A is connected to the drive unit 41D. The drive unit 41D includes, for example, a stepping motor, and can change an angle of the pulley shaft 41A in the longitudinal direction as indicated by a broken line in FIG. 7. As the angle of the pulley shaft 41A is changed, an angle of the pulley 41P is changed as indicated by a broken line, and the rotation angle of the multicore optical fiber 1 pinched in the groove of the pulley 41P around the axis is changed as indicated by a broken line.

Although FIG. 7 illustrates a configuration in which the rotation angle of one multicore optical fiber 1 is changed, the fiber rotation unit 41 has the same number of configurations of FIG. 7 as the number of multicore optical fibers 1, and can individually change the rotation angles of the plurality of multicore optical fibers 1. The groove of the pulley 41P is not limited to the V-shaped groove. For example, a U-shaped groove of which a bottom portion is formed in a curved shape and a curvature radius of the bottom portion may be substantially similar to a radius of the multicore optical fiber 1 from the viewpoint of increasing a contact area between the multicore optical fiber 1 and the pulley 41P and easily rotating the multicore optical fiber 1 around the axis.

The fiber bending unit 42 bends the multicore optical fiber 1 whose rotation angle has been changed in a predetermined direction. The fiber bending unit 42 includes a pair of pulleys 42a and 42b. The pulleys 42a and 42b have, for example, a configuration in which the same number of pulleys as the number of the multicore optical fibers 1 are stacked, the pulleys being similar to the pulley 41P. Therefore, the fiber bending unit 42 can bend each multicore optical fiber 1 under the same condition. Diameters of the pulleys 42a and 42b may be different from each other. A bending radius of the multicore optical fiber 1 may be 5 mm or more and 30 mm or less. The plurality of multicore optical fibers 1 fed from the fiber rotation unit 41 are bent by 360° by the pulleys 42a and 42b in the fiber bending unit 42. Each multicore optical fiber 1 may be wound a plurality of number of times around the pulleys 42a and 42b and bent by 360° or more. In addition, radii of the pulleys 42a and 42b may be different from each other, and the multicore optical fiber 1 may be bent at a different curvature radius.

The multicore optical fiber 1 is wound around the pulleys 42a and 42b such that an arrangement direction of the cores 11 and 13 of the multicore optical fiber 1 of FIG. 5 substantially coincides with a radial direction of the pulleys 42a and 42b in the fiber bending unit 42. That is, the arrangement direction of the cores 11 and 13 of the multicore optical fiber 1 of FIG. 5 substantially coincides with an x direction of FIG. 1, and the bending direction of the multicore optical fiber 1 illustrated in FIG. 2 coincides with the x direction. A configuration in which the multicore optical fiber 1 is wound around the pulleys 42a and 42b in this manner is described below.

The same number of optical fibers 43a and 43b as the number of multicore optical fibers 1 to be aligned are connected to the network analyzer 43. One optical fiber 43a and one optical fiber 43b correspond to one multicore optical fiber 1. The network analyzer 43 emits light of a predetermined wavelength to each optical fiber 43a, and measures a group delay of each light in a case where the light is incident from the optical fiber 43b corresponding to each optical fiber 43a via a predetermined path. The network analyzer 43 outputs a signal indicating the measured group delay. The light emitted from the network analyzer 43 to each optical fiber 43a propagates to any one of the cores 11 and 13 in each multicore optical fiber 1. The network analyzer 43 may be implemented by using the same number of single-channel network analyzers as the number of multicore optical fibers 1, in which one optical fiber 43a and one optical fiber 43b are connected.

A plurality of the optical fibers 43a and a plurality of optical fibers 44a and 44b for emission are connected to the channel selector 44. The number of optical fibers 44a and optical fibers 44b is the same as the number of multicore optical fibers 1, one optical fiber 44a and one optical fiber 44b are paired, and one pair corresponds to one multicore optical fiber 1 and one optical fiber 43a. In addition, the optical fiber 44a and the optical fiber 44b are optical fibers having the same characteristics, and have the same length. The light incident from one optical fiber 43a is incident on any one of the optical fibers 44a and 44b that are paired. For each pair, the channel selector 44 switches to which of the optical fibers 44a and 44b the light incident from the optical fiber 43a is emitted. The fan-in device 45 is connected between each of the optical fibers 44a and 44b and the multicore optical fiber 31F of the optical rotary joint of the feeding unit 31. The fan-in device 45 includes, for example, a plurality of waveguides and a plurality of optical fibers individually connected to the respective waveguides. Each optical fiber 44a is individually and optically connected to the core 11 of each multicore optical fiber 1 via the fan-in device 45 and the multicore optical fiber 31F, and each optical fiber 44b is optically connected to the core 13 of each multicore optical fiber 1 via the fan-in device 45 and the multicore optical fiber 31F.

With the above configuration, the light incident from the network analyzer 43 on each optical fiber 43a is individually incident on any one of the cores 11 and 13 of each multicore optical fiber 1 via the channel selector 44, the fan-in device 45, and the multicore optical fiber 31F.

The channel selector 47 has a configuration similar to that of the channel selector 44. However, the same number of optical fibers 43b for emission as the number of plurality of optical fibers 43a are connected to the channel selector 47, and the same number of pairs of optical fibers 47a and 47b for incidence as the number of pairs of plurality of optical fibers 44a and 44b are connected to the channel selector 47. The optical fiber 47a and the optical fiber 47b are optical fibers having the same characteristics, and have the same length. Light incident from any one of the optical fibers 47a and 47b that are paired is incident on one optical fiber 43b. For each pair, the channel selector 47 switches from which of the optical fibers 47a and 47b the light emitted to the optical fiber 43b is incident. The fan-out device 46 is connected between the plurality of multicore optical fibers 32F of the optical rotary joint of the winding unit 32 and each of the optical fibers 47a and 47b. The fan-out device 46 has, for example, a configuration similar to that of the fan-in device 45. Each optical fiber 47a is individually and optically connected to the core 11 of the multicore optical fiber 1 via the multicore optical fiber 32F and the fan-out device 46, and each optical fiber 47b is individually and optically connected to the multicore optical fiber 32F and the core 13 via the fan-out device 46.

With the above configuration, the light emitted from any one of the cores 11 and 13 of each multicore optical fiber 1 is individually incident on the network analyzer 43 via the multicore optical fiber 32F, the fan-out device 46, and the channel selector 47.

The network analyzer 43 is electrically connected to the arithmetic operation unit 48, and the signal indicating the group delay output from the network analyzer 43 is input to the arithmetic operation unit 48. The arithmetic operation unit 48 includes an arithmetic operation device including a difference circuit. The arithmetic operation unit 48 calculates the skew value S from the signal indicating the group delay of each light input from the network analyzer 43. The skew value S is calculated for each multicore optical fiber 1. A signal indicating the skew value S calculated by the arithmetic operation unit 48 is output to the control unit 49.

The skew measurement unit 40 having the above configuration measures the skew value S of the light propagating through the pair of cores 11 and 13 of the multicore optical fiber 1.

The control unit 49 includes, for example, an integrated circuit such as a microcontroller, an integrated circuit (IC), a large-scale integrated circuit (LSI), or an application specific integrated circuit (ASIC), or a numerical control (NC) device. In addition, in a case where the NC device is used, the control unit 49 may use a machine learning device or does not have to use a machine learning device. The control unit 49 controls the fiber rotation unit 41 based on the signal indicating the skew value S output from the arithmetic operation unit 48. Specifically, the control unit 49 controls the fiber rotation unit 41 to adjust the rotation angle of the multicore optical fiber 1 around the axis such that the skew value S has a predetermined value. The control unit 49 adjusts the rotation angle of the multicore optical fiber 1 such that the skew value S has a maximum value.

Next, a manufacturing method for the multicore optical fiber ribbon 2 will be described.

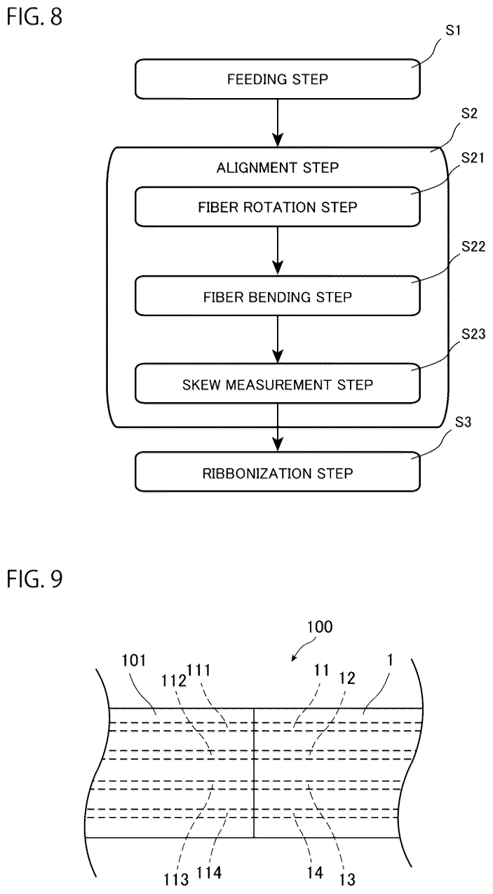

FIG. 8 is a flowchart illustrating the manufacturing method for the multicore optical fiber ribbon 2. As illustrated in FIG. 8, the manufacturing method for the multicore optical fiber ribbon 2 includes a feeding step S1, an alignment step S2, and a ribbonization step S3. The alignment step S2 includes a fiber rotation step S21, a fiber bending step S22, and a skew measurement step S23. The alignment step S2 implements an alignment method for aligning the orientation of the multicore optical fiber 1 in the rotation direction.

### (Feeding Step S1)

This step is a step of feeding the plurality of multicore optical fibers 1. Specifically, the winding unit 32 rotates by a drive unit (not illustrated) to wind the multicore optical fiber ribbon 2, so that each multicore optical fiber 1 is pulled and the plurality of multicore optical fibers 1 wound around the feeding unit 31 are fed. A ribbon puller may be provided in front of the winding unit 32, and the multicore optical fiber ribbon 2 may be pulled by the ribbon puller.

### (Fiber Rotation Step S21)

This step is a step of changing the rotation angle of the multicore optical fiber 1 around the axis. The plurality of multicore optical fibers 1 fed from the feeding unit 31 are fed to the fiber rotation unit 41. In the fiber rotation unit 41, when the multicore optical fiber 1 enters the groove of the pulley 41P and an inclination of the pulley 41P is changed, the rotation angle of the multicore optical fiber 1 around the axis is changed by the change in the inclination as described with reference to FIG. 7. The inclination of the pulley 41P is appropriately changed according to an instruction from the control unit 49. Therefore, the rotation angle of the multicore optical fiber 1 is also appropriately changed according to an instruction from the control unit 49. The plurality of multicore optical fibers 1 whose rotation angles have been changed are fed from the fiber rotation unit 41 while substantially maintaining the rotation angles.

### (Fiber Bending Step S22)

This step is a step of bending the multicore optical fiber 1 whose rotation angle has been changed in the predetermined direction. The multicore optical fiber 1 fed from the fiber rotation unit 41 is fed to the fiber bending unit 42. In the fiber bending unit 42, the multicore optical fiber 1 is bent by the pulleys 42a and 42b as described above. Therefore, a skew occurs in the light propagating through the pair of cores 11 and 13 of the multicore optical fiber 1. As described with reference to FIG. 4, the skew value S is changed depending on a relationship between the arrangement direction of the pair of cores 11 and 13 and the bending direction of the multicore optical fiber 1. The multicore optical fiber 1 is bent by the pulleys 42a and 42b such that the bending direction of the multicore optical fiber 1 coincides with the arrangement direction of the cores 11 and 13. That is, the fiber rotation unit 41 changes the rotation angle of the multicore optical fiber 1 such that the multicore optical fiber 1 is bent by the pulleys 42a and 42b as described above. In this case, the angle θ between the bending direction and the arrangement direction of the cores 11 and 13 in FIG. 4 is approximately 0°, and the skew value S is approximately the maximum. The multicore optical fiber 1 may be wound around the pulleys 42a and 42b a plurality of times as described above because the skew value S increases. Each multicore optical fiber 1 is bent in the fiber bending unit 42 and then fed from the fiber bending unit 42.

### (Skew Measurement Step S23)

This step is a step of causing the light to enter the pair of cores 11 and 13 of the multicore optical fiber 1, receiving the light emitted from the pair of cores 11 and 13, and measuring the skew value S of the light. The network analyzer 43 causes the light of the predetermined wavelength to enter each optical fiber 43a. In the channel selector 44, for example, first, a channel is set such that the light from the optical fiber 43a propagates to the optical fiber 44a. Therefore, the light emitted from the network analyzer 43 is incident on the core 11 of each multicore optical fiber 1 via the channel selector 44, the fan-in device 45, and the like. The group delay occurs in the light propagating through the core 11. The light emitted from the core 11 of each multicore optical fiber 1 is incident on the network analyzer 43 via the fan-out device 46 and the channel selector 47. In the network analyzer 43, the group delay of each light is measured, and the signal including the group delay of each light is output to the arithmetic operation unit 48. Next, the channel selector 44 sets the channel such that the light from the optical fiber 43a propagates to each optical fiber 44b. Therefore, each light is incident on the core 13 of each multicore optical fiber 1. The group delay occurs in the light propagating through the core 13, the group delay of each light incident on the network analyzer 43 is measured, and the signal including the group delay of each light is output to the arithmetic operation unit 48. The group delay varies depending on a curvature radius of the core through which the light propagates. Therefore, in the fiber bending unit 42, the group delay is different between the light propagating through the core 11 and the light propagating through the core 13 depending on the curvature radii of the cores 11 and 13 defined by the pulleys 42a and 42b. The arithmetic operation unit 48 calculates the skew value S based on two group delays propagating through the cores 11 and 13. In this way, the skew value S of each multicore optical fiber 1 is measured for each multicore optical fiber 1. The signal including the calculated skew value S is output to the control unit 49.

The control unit 49 controls the fiber rotation unit 41 such that the skew value S has the predetermined value based on the signal including the skew value S input from the arithmetic operation unit 48. That is, in the fiber rotation step S21, the rotation angle of the multicore optical fiber 1 is adjusted such that the skew value S has the predetermined value. The fiber rotation unit 41 is controlled such that the skew value S is maximized. In a case where the skew value S decreases, the control unit 49 controls the drive unit 41D of the fiber rotation unit 41 to change the rotation angle of the multicore optical fiber 1 such that, for example, the arrangement direction of the cores 11 and 13 moves to a +θ side. At this time, in a case where the skew value S further decreases, the rotation angle of the multicore optical fiber 1 is changed such that the arrangement direction of the cores 11 and 13 moves to a −θ side. Therefore, the multicore optical fiber 1 is bent by the pulleys 42a and 42b such that the bending direction of the multicore optical fiber 1 coincides with the arrangement direction of the cores 11 and 13 as described above. In this way, the orientation of each multicore optical fiber 1 in the rotation direction around the axis is aligned.

### (Ribbonization Step S3)

This step is a step of ribbonizing the plurality of multicore optical fibers 1 aligned in the alignment step S2. In the alignment step S2, the orientation of each multicore optical fiber 1 in the rotation direction is aligned, and the multicore optical fiber 1 is fed from the fiber bending unit 42 to the ribbonization unit 33. In the ribbonization unit 33, the outer circumferential surface of each multicore optical fiber 1 is covered with the uncured resin to be the ribbon coating 21, and the resin is cured to ribbonize the plurality of multicore optical fibers 1. In this way, the multicore optical fiber ribbon 2 illustrated in FIG. 5 is manufactured.

The multicore optical fiber ribbon 2 is wound around the winding unit 32.

As described above, in the alignment device 4 for the multicore optical fiber 1 and the alignment method for the multicore optical fiber 1, the rotation angle of the multicore optical fiber 1 around the axis is changed, the multicore optical fiber 1 whose rotation angle has been changed is bent in the predetermined direction, the skew value S of the light propagating through the pair of cores 11 and 13 of the multicore optical fiber 1 is measured, and when the multicore optical fiber 1 is rotated, the rotation angle of the multicore optical fiber 1 is adjusted such that the skew value S has the predetermined value. The arrangement direction of the pair of cores can be set to a predetermined direction with respect to the bending direction by adjusting the rotation angle such that the skew value S has the predetermined value. Since the change in the skew value S with respect to the rotation angle can be measured more precisely than a change in leaked light, it is possible to perform alignment in the rotation direction with high accuracy with the alignment device 4 for the multicore optical fiber 1 and the alignment method for the multicore optical fiber 1.

In the alignment device 4 for the multicore optical fiber 1 and the alignment method for the multicore optical fiber 1, the rotation angle is adjusted such that the skew value S has the maximum value. The rotation angle may be adjusted such that the skew value S has a minimum value. In these cases, an absolute value of the skew value S is larger than those when the rotation angle is adjusted such that the skew value S has the predetermined value between the maximum value and the minimum value, a resolution of the skew value S can be increased, and the alignment can be performed with higher accuracy. In a case where the arrangement direction of the pair of cores 11 and 13 coincides with the bending direction, the skew value S is maximized or minimized. Therefore, the arrangement direction of the pair of cores 11 and 13 coincides with the bending direction, the arrangement direction of the pair of cores 11 and 13 can be easily grasped, and the aligned multicore optical fiber 1 can be easily handled. In the alignment device 4 for the multicore optical fiber 1 and the alignment method for the multicore optical fiber 1, the rotation angle may be adjusted such that the skew value S has the predetermined value that is not the maximum value. In this case, the arrangement direction of the cores 11 and 13 coincides with a direction other than a direction perpendicular to the arrangement direction of the multicore optical fibers 1 in the multicore optical fiber ribbon 2. For example, the rotation angle may be adjusted such that the skew value S becomes zero. In this case, the arrangement direction of the cores 11 and 13 coincides with the arrangement direction of the multicore optical fibers 1. Alternatively, the rotation angle may be adjusted such that the arrangement direction of the cores 11 and 13 has the skew value S that forms, for example, 45° with respect to the arrangement direction of the multicore optical fibers 1.

In the alignment device 4 for the multicore optical fiber 1 and the alignment method for the multicore optical fiber 1, the pair of cores 11 and 13 for which the skew value S is measured is a core pair that is farthest from each other among the plurality of cores 11 to 14 in the multicore optical fiber 1. Therefore, when the rotation angle of the multicore optical fiber 1 deviates, the change in the skew value S increases. Therefore, the skew value S can be measured with higher accuracy, and the alignment can be performed with higher accuracy. The core pair for which the skew value S is measured does not have to be the core pair that is farthest from each other. For example, the skew value S of the light propagating through the cores 11 and 12 may be measured. In this case, if the rotation angle is adjusted such that the skew value S has the maximum value, the cores 11 and 12 are arranged in the direction perpendicular to the arrangement direction of the multicore optical fibers 1, and the cores 11 and 13 are arranged in a direction forming 45° with respect to the direction perpendicular to the arrangement direction of the multicore optical fibers 1.

In addition, in the manufacturing device 3 for the multicore optical fiber ribbon 2 and the manufacturing method for the multicore optical fiber ribbon 2, the plurality of multicore optical fibers 1 are fed, the orientations of the fed multicore optical fibers 1 in the rotation direction are aligned by the above-described alignment, and the plurality of aligned multicore optical fibers 1 are ribbonized. With the manufacturing device 3 and the manufacturing method for the multicore optical fiber ribbon 2, it is possible to manufacture the multicore optical fiber ribbon 2 in which the rotation directions of the multicore optical fibers 1 are aligned with high accuracy.

The alignment of the plurality of multicore optical fibers 1 included in the multicore optical fiber ribbon 2 in the rotation direction is performed. However, the alignment of some multicore optical fibers 1 included in the multicore optical fiber ribbon 2 in the rotation direction may be performed, and the alignment of other multicore optical fibers 1 does not have to be performed. In this case, only the multicore optical fiber 1 to be aligned is fed from the feeding unit 31 to the ribbonization unit 33 via the alignment device 4, and some other multicore optical fibers 1 not to be aligned are fed from the feeding unit 31 to the ribbonization unit 33 without passing through the alignment device 4. In this case, it is sufficient if the fiber rotation unit 41, the fiber bending unit 42, and the skew measurement unit 40 have configurations capable of aligning the multicore optical fiber 1 to be aligned.

### Second Embodiment

Next, a second embodiment of the present invention will be described in detail with reference to FIGS. 9 to 11. The same or equivalent constituent elements as those of the first embodiment are denoted by the same reference numerals, and an overlapping description will be omitted unless otherwise specified.

FIG. 9 is a view illustrating a multicore optical fiber unit 100. In the example of FIG. 9, the multicore optical fiber unit 100 includes a multicore optical fiber 1 and a multicore optical fiber 101 that is another optical component, and the multicore optical fiber 1 and the multicore optical fiber 101 are connected. In this example, cores 11 to 14 of the multicore optical fiber 1 are individually connected to cores 111 to 114 of the multicore optical fiber 101. FIG. 9 schematically illustrates arrangement of the respective cores, and a protective layer 19 is omitted.

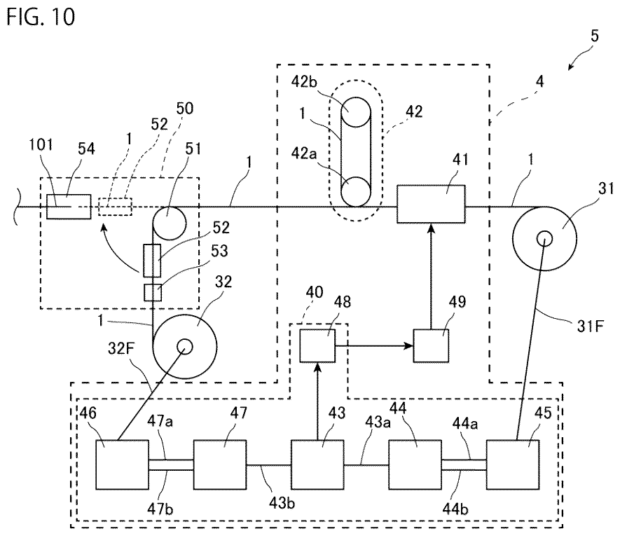

FIG. 10 is a view illustrating a manufacturing device for the multicore optical fiber unit 100. As illustrated in FIG. 10, a manufacturing device 5 for the multicore optical fiber unit 100 mainly includes a feeding unit 31, a winding unit 32, an alignment device 4, and a connection unit 50.

The manufacturing device 5 manufactures the multicore optical fiber unit 100 by individually connecting the cores 11 to 14 of one multicore optical fiber 1 to the cores 111 to 114 of another multicore optical fiber 101. Therefore, one multicore optical fiber 1 is wound around the feeding unit 31, and the winding unit 32 winds one multicore optical fiber 1. Therefore, in the alignment device 4, alignment of one multicore optical fiber 1 in a rotation direction is performed.

The connection unit 50 connects the multicore optical fiber 1 aligned by the alignment device 4 to the another multicore optical fiber 101. The connection unit 50 includes a pulley 51, a fiber rotation fixing movement portion 52, a fiber cutting portion 53, and a splicing portion 54. The pulley 51 has, for example, a configuration similar to that of a pulley 41P. The fiber cutting portion 53 includes, for example, an optical fiber cutter, and can cut the multicore optical fiber 1. The fiber rotation fixing movement portion 52 has, for example, a configuration capable of pinching an outer circumferential surface of the multicore optical fiber 1 from three directions, and can switch between fixation and non-fixation of rotation of the multicore optical fiber 1 around an axis. The fiber rotation fixing movement portion 52 can move, to the splicing portion 54, an end portion of the multicore optical fiber 1 formed by cutting the multicore optical fiber 1 as indicated by a broken line after the multicore optical fiber 1 is cut by the fiber cutting portion 53 in a state in which the rotation of the multicore optical fiber 1 is fixed.

An end portion of the multicore optical fiber 101 is set in the splicing portion 54. As described in FIG. 9, the respective cores 111 to 114 of the multicore optical fiber 101 are arranged symmetrically with the cores 11 to 14, and can face the cores 11 to 14 individually.

The splicing portion 54 includes, for example, a pair of discharge electrodes facing each other with the end portion of the multicore optical fiber 1 and the end portion of the multicore optical fiber 101 interposed therebetween, and the end portion of the multicore optical fiber 1 and the end portion of the multicore optical fiber 101 are spliced by heating due to discharge from the discharge electrodes. The splicing portion 54 may perform the splicing by another method.

Next, a manufacturing method for the multicore optical fiber unit 100 will be described.

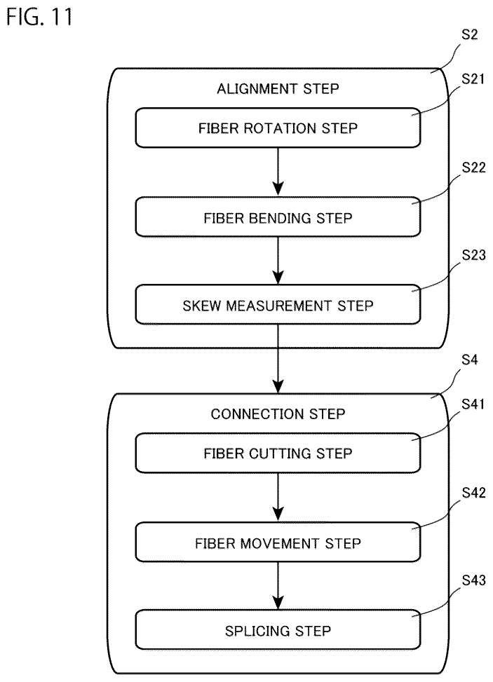

FIG. 11 is a flowchart illustrating the manufacturing method for the multicore optical fiber unit 100. As illustrated in FIG. 11, the manufacturing method for the multicore optical fiber unit 100 includes an alignment step S2 and a connection step S4. The alignment step S2 also implements an alignment method for aligning an orientation of the multicore optical fiber 1 in the rotation direction, and includes a fiber rotation step S21, a fiber bending step S22, and a skew measurement step S23. The connection step S4 is a step of connecting the cores 11 to 14 of the multicore optical fiber 1 aligned in the alignment step S2 to another waveguide. The connection step S4 includes a fiber cutting step S41, a fiber movement step S42, and a splicing step S43.

### (Alignment Step S2)

First, alignment of the multicore optical fiber 1 in the rotation direction is performed in the same manner as in the alignment step S2 according to the first embodiment. However, in one or more embodiments, only the alignment of one multicore optical fiber 1 is performed.

### (Fiber Cutting Step S41)

This step is a step of cutting the multicore optical fiber 1. When a portion in which the rotation direction of the multicore optical fiber 1 has been aligned in the alignment step S2 moves to the fiber cutting portion 53 via the pulley 51, the winding unit 32 stops winding the multicore optical fiber 1, and accordingly, the feeding unit 31 stops feeding the multicore optical fiber 1. The fiber rotation fixing movement portion 52 fixes the rotation of the multicore optical fiber 1 such that the multicore optical fiber 1 does not rotate, in a state in which the movement of the multicore optical fiber 1 is stopped. Thereafter, the fiber cutting portion 53 cuts the multicore optical fiber 1. The rotation direction of the end portion of the multicore optical fiber 1 formed by the cutting is aligned.

### (Fiber Movement Step S42)

This step is a step of moving the end portion of the multicore optical fiber 1 to the splicing portion 54. The fiber rotation fixing movement portion 52 moves the end portion of the multicore optical fiber 1 such that the end portion is positioned in the splicing portion 54 while fixing the rotation of the multicore optical fiber 1. At this time, for example, the fiber rotation fixing movement portion 52 rotates by approximately 90° so as to suppress a change in tension applied to the multicore optical fiber 1.

### (Splicing Step S43)

This step is a step of splicing the multicore optical fiber 1 and the multicore optical fiber 101. The respective cores 11 to 14 of the moved multicore optical fiber 1 and the cores 111 to 114 of the multicore optical fiber 101 face each other. In the alignment step S2, the alignment is performed such that the cores 11 to 14 and the cores 111 to 114 individually face each other after the fiber movement step S42. In this step, for example, the end portion of the multicore optical fiber 1 and the end portion of the multicore optical fiber 101 are melted by discharge or the like, and the respective end portions are brought into contact with each other to perform the splicing. At this time, since the cores 11 to 14 and the cores 111 to 114 individually face each other, the cores 11 to 14 and the cores 111 to 114 are fusion-spliced to each other. In this way, the multicore optical fiber 1 and the multicore optical fiber 101 are connected, and the multicore optical fiber unit 100 illustrated in FIG. 9 is manufactured.

In the manufacturing device 5 for the multicore optical fiber unit 100 and a connection method for the multicore optical fiber unit 100, the cores 11 to 14 of the multicore optical fiber 1 aligned by the alignment device 4 or the alignment method are connected to another optical element. Therefore, since the multicore optical fiber 1 is connected in a state in which the rotation direction of the multicore optical fiber 1 is aligned with high accuracy, it is possible to manufacture the multicore optical fiber unit 100 in which the multicore optical fiber 1 whose rotation direction has been appropriately aligned is connected to the multicore optical fiber 101 which is another optical component. Therefore, in the multicore optical fiber unit 100 of this example, the cores 11 to 14 can appropriately face the cores 111 to 114, and leakage of light at a connection portion can be suppressed.

The connection unit 50 includes the pulley 51, the fiber rotation fixing movement portion 52, the fiber cutting portion 53, and the splicing portion 54, but the pulley 51, the fiber rotation fixing movement portion 52, the fiber cutting portion 53, and the splicing portion 54 are not essential as long as the cores 11 to 14 of the multicore optical fiber 1 aligned by the alignment device 4 can be connected to another optical component. For example, an example of connection by the splicing has been described, but connection by crimping may also be used. In this case, the connection unit 50 includes a crimping portion instead of the splicing portion 54, and the connection step S4 includes a crimping step instead of the splicing step S43. Then, the crimping step is performed after the end portion of the multicore optical fiber 1 is moved in the fiber movement step S42 as in one or more of the above embodiments, and in the crimping step, the crimping portion crimps the end portion of the multicore optical fiber 1 to the end portion of the multicore optical fiber 101.

In one or more embodiments, the multicore optical fiber 101 has been described as an example of the optical component. However, the optical component does not have to be the multicore optical fiber 101 as long as the optical component is connected to the multicore optical fiber 1. The optical component may be, for example, a waveguide substrate, a fan-in-fan-out device, a multicore optical connector, or the like. In addition, the optical component may be optically connected to only some of the cores 11 to 14 of the multicore optical fiber 1.

The optical component may not be optically coupled to the cores 11 to 14 as long as the optical component is connected to the multicore optical fiber 1, like a ferrule. For example, in a case where the optical component is the ferrule, the connection unit 50 includes an insertion portion instead of the splicing portion 54, and the connection step S4 includes an insertion step instead of the splicing step S43. Then, the insertion step is performed after the end portion of the multicore optical fiber 1 is moved in the fiber movement step S42 as in one or more of the above embodiments, and in the insertion step, the insertion portion relatively moves the multicore optical fiber 1 and the ferrule such that the end portion of the multicore optical fiber 1 is inserted into the ferrule, and the multicore optical fiber 1 and the ferrule are connected. Therefore, the multicore optical fiber unit in which the multicore optical fiber 1 and the ferrule are connected in a state in which the multicore optical fiber 1 is aligned in the rotation direction with high accuracy is manufactured. In a case where the ferrule is housed in a housing of an optical fiber connector, the optical fiber connector serves as the multicore optical fiber unit.

One or more examples in which one multicore optical fiber 1 is connected to the optical component have been described above. However, alignment of a plurality of multicore optical fibers 1 in the rotation direction may be performed, and the plurality of multicore optical fibers 1 may be connected to the optical component. The plurality of multicore optical fibers 1 can be aligned by, for example, the alignment device 4 according to the first embodiment.

### Third Embodiment

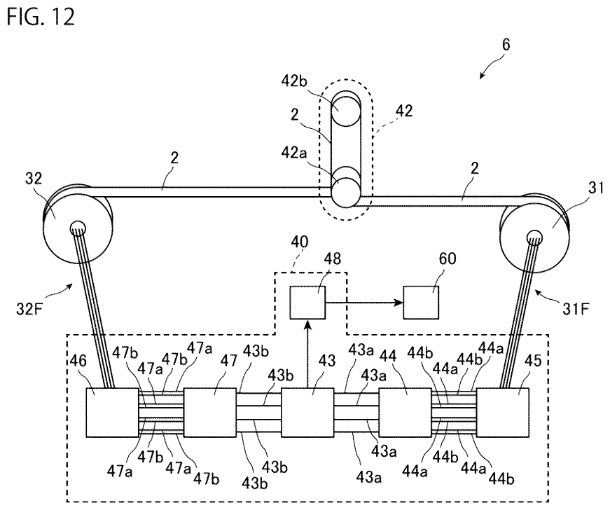

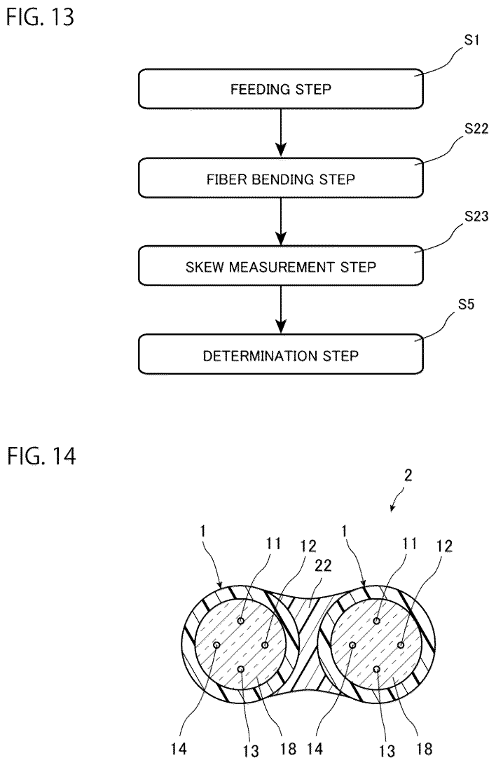

Next, a third embodiment of the present invention will be described in detail with reference to FIGS. 12 and 13. The same or equivalent constituent elements as those of the first embodiment are denoted by the same reference numerals, and an overlapping description will be omitted unless otherwise specified.

FIG. 12 is a diagram illustrating an inspection device for a multicore optical fiber ribbon 2. As illustrated in FIG. 12, an inspection device 6 for the multicore optical fiber ribbon 2 mainly includes a feeding unit 31, a fiber bending unit 42, a winding unit 32, a network analyzer 43, channel selectors 44 and 47, a fan-in device 45, a fan-out device 46, an arithmetic operation unit 48, and a determination unit 60.

The multicore optical fiber ribbon 2 is wound around the feeding unit 31. One ends of respective multicore optical fibers 1 of the multicore optical fiber ribbon 2 are optically and individually connected to the same number of multicore optical fibers 31F as the number of multicore optical fibers 1 in the first embodiment. In pulleys 42a and 42b in the fiber bending unit 42, a width of a groove is larger than a width of the multicore optical fiber ribbon 2 in an arrangement direction of the multicore optical fibers 1, and a bottom portion of the groove is formed to be flat. Therefore, the multicore optical fiber ribbon 2 can be bent in a direction perpendicular to the arrangement direction of the multicore optical fibers 1.

The arithmetic operation unit 48 outputs a calculated skew value S to the determination unit 60. The determination unit 60 has a configuration similar to that of a control unit 49, for example, and determines that the skew value S is outside a predetermined range. For example, an arrangement direction of cores 11 and 13 of the multicore optical fiber 1 is the direction perpendicular to the arrangement direction of the multicore optical fibers 1 in the multicore optical fiber ribbon 2 as illustrated in FIG. 5, and the skew value of light propagating through the cores 11 and 13 of each multicore optical fiber 1 is measured similarly to the first embodiment. In this case, the predetermined range is, for example, a range from a maximum value of the skew value S to a value 1% lower than the maximum value. In a case where the skew value S of any one of the multicore optical fibers 1 is outside the predetermined range, the determination unit 60 outputs which position in a longitudinal direction of which multicore optical fiber 1 is outside the predetermined range.

Next, an inspection method for the multicore optical fiber ribbon 2 will be described.

FIG. 13 is a flowchart illustrating the inspection method for the multicore optical fiber ribbon 2. As illustrated in FIG. 13, the inspection method for the multicore optical fiber ribbon 2 includes a feeding step S1, a fiber bending step S22, a skew measurement step S23, and a determination step S5.

### (Feeding Step S1)

In this step, the multicore optical fiber ribbon 2 including the plurality of multicore optical fibers 1 is fed from the feeding unit 31.

### (Fiber Bending Step S22)

In this step, each multicore optical fiber 1 is bent by bending the multicore optical fiber ribbon 2. The multicore optical fiber ribbon 2 fed from the feeding unit 31 is fed to the fiber bending unit 42 and bent in a predetermined direction by the pulleys 42a and 42b. At this time, the fiber bending unit 42 bends the multicore optical fiber ribbon 2 in a thickness direction thereof. This direction is perpendicular to the arrangement direction of the multicore optical fibers 1, and is the arrangement direction of the cores 11 and 13.

### (Skew Measurement Step S23)

This step is a step of causing light to enter a pair of cores 11 and 13 in each multicore optical fiber 1, receiving the light emitted from the pair of cores 11 and 13 in each multicore optical fiber 1, and measuring the skew value S of each light for each multicore optical fiber 1. The skew value S is measured in the same manner as in the first embodiment.

### (Determination Step S5)

This step is a step of determining that the skew value S in at least one multicore optical fiber 1 is outside the predetermined range. When the skew value S is input from the arithmetic operation unit 48, the determination unit 60 determines whether or not the skew value S is outside the predetermined range. In a case where the skew value S is within the predetermined range, for example, the determination unit 60 does not particularly output a signal. In a case where the skew value S is outside the predetermined range, the determination unit 60 outputs a signal indicating the multicore optical fiber 1 in which the skew value S is outside the predetermined range and a signal indicating a position of the multicore optical fiber 1 in which the skew value S is outside the predetermined range in the longitudinal direction.

In the inspection device 6 for the multicore optical fiber ribbon 2 and the inspection method for the multicore optical fiber ribbon 2, misalignment of the multicore optical fiber 1 is detected by using the skew value S that is outside the predetermined range at a portion bent by the fiber bending unit 42, so that the misalignment of the multicore optical fiber 1 can be detected with high accuracy.

Since the multicore optical fiber ribbon 2 is sequentially fed to the fiber bending unit 42, the misalignment of the multicore optical fiber 1 can be detected in the longitudinal direction. Therefore, it is possible to detect a section in which the misalignment of the multicore optical fiber 1 in a rotation direction has occurred with high accuracy. The multicore optical fiber ribbon 2 is not necessarily fed to the fiber bending unit 42. For example, in a case of the multicore optical fiber ribbon 2 in which the rotation direction of the multicore optical fiber 1 hardly changes in the longitudinal direction, the multicore optical fiber 1 in the multicore optical fiber ribbon 2 is bent at the fiber bending unit 42, and the skew value S is measured, so that it is possible to specify the multicore optical fiber 1 in which the misalignment in the rotation direction has occurred.

In one or more embodiments, the predetermined range may be a range from the minimum value of the skew value S to a value 1% higher than the minimum value. Further, the pair of cores for measuring the skew value S do not have to be arranged in the thickness direction of the multicore optical fiber ribbon 2. In addition, the pair of cores may be arranged in the thickness direction of the multicore optical fiber ribbon 2 because the misalignment of the multicore optical fiber 1 in the rotation direction can be detected with higher accuracy by increasing the skew value S.

In one or more embodiments, the misalignment of the plurality of multicore optical fibers 1 included in the multicore optical fiber ribbon 2 is detected. However, the misalignment of some multicore optical fibers 1 included in the multicore optical fiber ribbon 2 may be detected, and the misalignment of the other multicore optical fibers 1 may not be detected. In this case, only the multicore optical fiber 1 for which the detection of the misalignment has been performed may be connected to the skew measurement unit 40. In this case, it is sufficient if the skew measurement unit 40 has a configuration capable of measuring the skew value of the multicore optical fiber 1 for which the misalignment is detected.

Although the present invention has been described with reference to the above-described embodiments as examples, the present invention is not limited thereto.

For example, the number and arrangement of cores of the multicore optical fiber 1 may be different from those in the above embodiments. The cores of the multicore optical fiber 1 may be arranged in a linear shape, an annular shape, or a lattice shape.

In addition, a configuration of the multicore optical fiber ribbon 2 may be different from that illustrated in FIG. 5. For example, the number of multicore optical fibers 1 included in the multicore optical fiber ribbon 2 can be appropriately changed. In addition, all the optical fibers included in the multicore optical fiber ribbon 2 do not need to be the multicore optical fibers 1, and the multicore optical fiber ribbon 2 may include at least one multicore optical fiber 1. Therefore, for example, the multicore optical fiber ribbon 2 may include one or more multicore optical fibers 1 and one or more single-core optical fibers. In this case, an alignment device 4 aligns at least one multicore optical fiber 1 in the rotation direction.

FIG. 14 is a diagram illustrating a modified example of the multicore optical fiber ribbon 2. As illustrated in FIG. 14, the multicore optical fiber ribbon 2 may be formed by fixing the plurality of multicore optical fibers 1 adjacent to each other with a fixing resin 22. FIG. 14 illustrates a case where there are two multicore optical fibers 1, but there may be three or more multicore optical fibers 1. Further, the fixing resin 22 may be provided in a fragmentary manner in the longitudinal direction of the multicore optical fiber 1. In a case where such a fixing resin 22 is used, the multicore optical fiber 1 is easily displaced in the rotation direction as compared with the multicore optical fiber ribbon 2 illustrated in FIG. 5. Therefore, in the third embodiment, a tension when inspecting the multicore optical fiber ribbon 2 may be increased. In the present modified example, the multicore optical fiber ribbon 2 may also include one or more multicore optical fibers 1 and one or more single-core optical fibers.

Further, in the first and third embodiments, the plurality of optical fibers 43a and 43b are connected to the network analyzer 43, but one optical fiber 43a and one optical fiber 43b may be connected to the network analyzer 43. In this case, the channel selector 44 switches the optical path so as to propagate the light in order to the plurality of multicore optical fibers 1, and the channel selector 47 switches the optical path so as to emit the light incident from one of the plurality of optical fibers 47a and 47b to the optical fiber 43b.

In addition, the alignment device 4 may include a memory having a table indicating a relationship between the angle θ formed by the arrangement direction of the pair of cores and the bending direction and the skew value S. In this case, the control unit 49 may adjust the rotation angle of the multicore optical fiber 1 in the fiber rotation unit 41 by performing calculation from the measured skew value S and the table with reference to the memory.

The feeding unit and the winding unit do not have to use the reel. For example, the multicore optical fiber 1 may be pulled out from a folded state or a coiled state as long as the multicore optical fiber 1 is not damaged, and may be pulled in a similar state instead of being wound.

The skew measurement unit 40 may have another configuration as long as the skew value S of the light propagating through the pair of cores of the multicore optical fiber 1 can be measured.

As described above, embodiments of the present invention provides the alignment device for a multicore optical fiber capable of achieving alignment of the multicore optical fiber in the rotation direction with high accuracy, the manufacturing device for a multicore optical fiber ribbon, the connection device for a multicore optical fiber, the alignment method for a multicore optical fiber, the manufacturing method for a multicore optical fiber ribbon, the connection method for a multicore optical fiber, the inspection device for a multicore optical fiber ribbon capable of detecting misalignment of the multicore optical fiber in the rotation direction with high accuracy, and the inspection method for a multicore optical fiber ribbon, which can be used in the fields of optical communication and the like.

1. An alignment device for a multicore optical fiber, the alignment device comprising:
a fiber rotator configured to change a rotation angle of the multicore optical fiber around an axis;
a fiber bender configured to bend the multicore optical fiber whose rotation angle has been changed in a predetermined direction;
a skew measurer configured to measure a skew value of light propagating through a pair of cores of the multicore optical fiber; and
a controller that controls the fiber rotator to adjust the rotation angle of the multicore optical fiber such that the skew value has a predetermined value.

2. The alignment device according to claim 1, wherein
the controller adjusts the rotation angle such that the skew value has a maximum value or a minimum value.

3. A manufacturing device for a multicore optical fiber ribbon, the manufacturing device comprising:
a feeder configured to feed one or more multicore optical fibers;
the alignment device according to claim 1 configured to perform alignment of an orientation of at least one multicore optical fiber fed from the feeder in a rotation direction; and
a ribbonization unit ribbonizer configured to ribbonize a plurality of optical fibers including the multicore optical fiber aligned by the alignment device.

4. A manufacturing device for a multicore optical fiber unit, the manufacturing device comprising:
the alignment device according to claim 1; and
a fiber connector configured to connect the multicore optical fiber aligned by the alignment device to another optical component.

5. An alignment method for a multicore optical fiber, the alignment method comprising:
changing a rotation angle of the multicore optical fiber around an axis;
bending the multicore optical fiber whose rotation angle has been changed in a predetermined direction; and
measuring a skew value of light propagating through a pair of cores of the multicore optical fiber,
wherein the rotation angle of the multicore optical fiber is changed such that the skew value has a predetermined value.

6. The alignment method according to claim 5, wherein
the rotation angle is changed such that the skew value has a maximum value or a minimum value.

7. The alignment method according to claim 5, wherein
the pair of cores is a core pair farthest from each other among a plurality of cores in the multicore optical fiber.

8. A manufacturing method for a multicore optical fiber ribbon, the manufacturing method comprising:
feeding one or more multicore optical fibers;
performing alignment of an orientation of at least one of the multicore optical fibers fed in a rotation direction by the alignment method according to claim 5; and
ribbonizing a plurality of the multicore optical fibers that are aligned.

9. A manufacturing method for a multicore optical fiber unit, the manufacturing method comprising:
performing alignment of an orientation of the multicore optical fiber in a rotation direction by the alignment method according to claim 5; and
connecting the multicore optical fiber that is aligned to another optical component.

10. An inspection device for a multicore optical fiber ribbon, the inspection device comprising:
a fiber bender configured to bend a multicore optical fiber by bending the multicore optical fiber ribbon including one or more multicore optical fibers;
a skew measurer configured to measure a skew value of light propagating through a pair of cores in at least one multicore optical fiber; and
a controller configured to determine that the skew value in at least one multicore optical fiber is outside a predetermined range.

11. An inspection method for a multicore optical fiber ribbon, the inspection method comprising:
bending a multicore optical fiber by bending the multicore optical fiber ribbon including one or more multicore optical fibers;
measuring a skew value of light propagating through a pair of cores in at least one multicore optical fiber; and
determining that the skew value in at least one multicore optical fiber is outside a predetermined range.

12. The inspection method according to claim 11, wherein
the multicore optical fiber ribbon includes a plurality of optical fibers arranged in parallel, the plurality of optical fibers including the multicore optical fiber, and
the pair of cores is arranged in a direction perpendicular to an arrangement direction of the plurality of optical fibers.
